(19) United States
(12) Patent Application Publication
(10) Pub. No.: US 2003/0041003 A1
(43) Pub. Date: Feb. 27, 2003

(54) Automated matching system for borrowers and savers

(76) Inventor: Leo Kayser III, New York, NY (US)

Correspondence Address: William L. Muckelroy, Esq., P.C., Ewing Professional Building, 1901 N. Olden Avenue, Suite 3A, Trenton, NJ, 08618, US

(21) Appl. No.: 09/882,007

(22) Filed: Jun. 15, 2001

Related U.S. Application Data
(60) Provisional application No. 60/212,718, filed on Jun. 20, 2000.

(51) Int. Cl. G06F 17/60

(52) U.S. Cl. 705/37

(57) ABSTRACT

A computer system and method, incorporating a computer network for conducting a savings and loan auction between a plurality of saver's institutions acting on behalf of a plurality of savers and a plurality of borrower's institutions acting on behalf of pre-qualified borrowers for a plurality of pre-set amounts of offered principal, each offered principal being offered for one of a plurality of pre-set time periods via a funds auctioneer, is provided. The system enables receiving an electronic savings deposit offer and ask rate from a prospective saver's institution over the network and an electronic loan request and bid rate from a prospective borrower's institution over the network. The funds auctioneer electronically sorts, matches, and selects electronic savings deposit offers and ask rates which match with electronic loan requests and bid rates to form a plurality of matches of bids and asks, or transactions, settles the transaction at the end of the loan and makes available to the borrower's institutions uncollateralized funds via a sterlization account during the terms of a loan.

### CROSS-REFERENCE TO RELATED APPLICATIONS AND PRIORITY CLAIM

The present application claims the benefit of a priority date based on applicant's co-pending U.S. Provisional Patent Application bearing serial No. 60/212,718, filed on Jun. 20, 2000.

### NOTICE OF COPYRIGHTED MATERIAL IN DISCLOSURE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to financial transactions via computer, specifically a system and method for effecting an electronic auction between borrowers pre-qualified via a borrower's institution and savers with available funds on deposit with a saver's institution using a third-party auctioneer such that the saver may select the bid at the highest rate of return and the borrower can offer the saver a selected rate of return.

2. Description of the Related Art

A related publication first appeared as web pages at “www.maxrate.com” on the internet in 1999 or 2000. The site was published by Maxrate.com, a corporation founded in 1999 to increase efficiency of the consumer's purchase process for certificates of deposit using an online bid as a vehicle by which its website, customer contacts, and a mission statement are published.

In 1998, Midorikawa et al. invented an electronic dealing system (EDS). This EDS, implemented on a general purpose computer used in processing transactions, established, managed and updated values of credit lines not only between individual customers but also between groups of customers or between one customer and one group of other customers. Plural customers are assembled as a subject, or home group for whom a common credit line is set relative to other customers or customer groups; further, an individual customer or individual group of customers can assemble other, plural customers as an object, or opposing, group and for whom a common credit line is set. A subject or home group may set a common credit line value relative to an individual object or opposing customer or group of customers, and in transaction matching processing in relation to a customer of the home group, a credit line check is performed using the common credit line value of the home group in establishing a transaction with an opposing customer or customer group and the established amount of the transaction is subtracted from the common credit line value of the home group. Using EDS, order side and hit side customers are electronically matched in the same manner borrowers and savers are matched in the current novel invention.

By 1999, Zandi was issued a patent for his “System and Method for Conducting Loan Auction Over a Computer Network.” This computer system was for conducting an electronic loan auction over a computer network such as the internet. The computer system included a computer connected to the internet, which performed the following functions: (1) receiving an electronic loan application form from a prospective borrower; (2) providing such application to a loan authorizer's computer over the computer network for approval; (3) receiving an electronic message from the loan authorizer's computer indicating whether or not such loan has been approved; (4) entering the loan application into a database that is accessible to lenders via the computer network, if the loan is approved; and (5) maintaining the loan application in the database for a predetermined period of time during which lenders submit bids and the borrower may accept a bid.

The present invention represents an improvement and a novel extension over U.S. Pat. No. 5,611,052 issued to Dykstra et al. on Mar. 11, 1997, U.S. Pat. No. 5,797,133 issued to Jones et al. on Aug. 18, 1998, U.S. Pat. No. 5,832,462 issued to Midoikawa et al. on Nov. 3, 1998, U.S. Pat. No. 5,878,4033 issued to Defrancesco et al. on Mar. 2, 1998, U.S. Pat. No. 5,966,699 issued to Zandi on Oct. 12, 1999 and U.S. Pat. No. 5,995,947 issued to Fraser et al. on Nov. 30, 1999, the disclosures of which are incorporated by reference herein in their entirety. These patents use a facsimile-based front end in which the potential borrower completes an optically scannable form by making black marks where indicated to represent the borrower's information. The form is faxed to the central location to be scanned and interpreted by a data processor. This information is used to determine the approval status and credit limit of the borrower prior to implementation of the novel invention herein by a borrower's institution.

### SUMMARY OF THE INVENTION

For institutions that qualify to use the system, the novel computer based savings and loan auctioneering system and network enables an automated transaction service that matches savers and borrowers throughout the world. Transactions are evidenced by promissory notes with fixed interest rates, maturities, and principal amounts in denominations ranging from $5,000 to $100,000.

The system is accessed through computer terminals, provided by the novel computer based savings and loan auctioneering at nominal cost to the institutions. Each terminal is linked to a state-of-the-art transaction based communications network or the internet. Through the auctioneering system, depository institutions submit a required rate of return (ask price), maturity and dollar amount on behalf of the saver, or a required borrowing rate (bid), maturity and dollar amount on behalf of the borrower. For specific maturities, which range from 1 to 5 years in six month increments, the central processing unit instantaneously matches bids with ask prices in fixed dollar amounts. Cash settlement (on behalf of borrowers and savers) is accomplished through a clearinghouse bank or merely a clearinghouse that is part of the novel computer based savings and loan auctioneering system. A novel sterilization account is employed by the funds auctioneer and enables a substantial increase in investable funds over the life of each loan.

The computer based savings and loan auctioneering system for institutions only is implemented over a communications network and thereby creates an efficient mechanism compared to present practice for savers and borrowers to meet via their financial institutions and enter into a transaction. Using the method and system, depository institutions compete on an equal basis for funds, regardless of size or geographic location while preserving benefits of their traditional customer relationships. The auctioneering system substantially reduces the liquidity risk associated with current banking practices. The method enables institutions to offer attractive borrowing and investment rates to their customers and concomitantly generate and receive a higher return on capital than with traditional lending.

### DESCRIPTION OF TIE PREFERRED EMBODIMENT

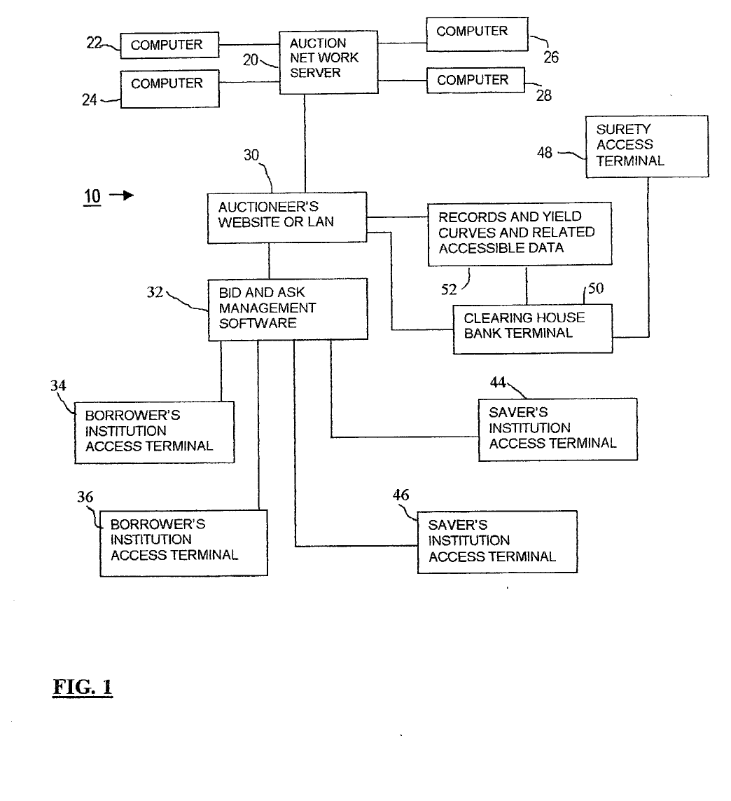

FIG. 1 is a block diagram of the computer system for the novel invention;

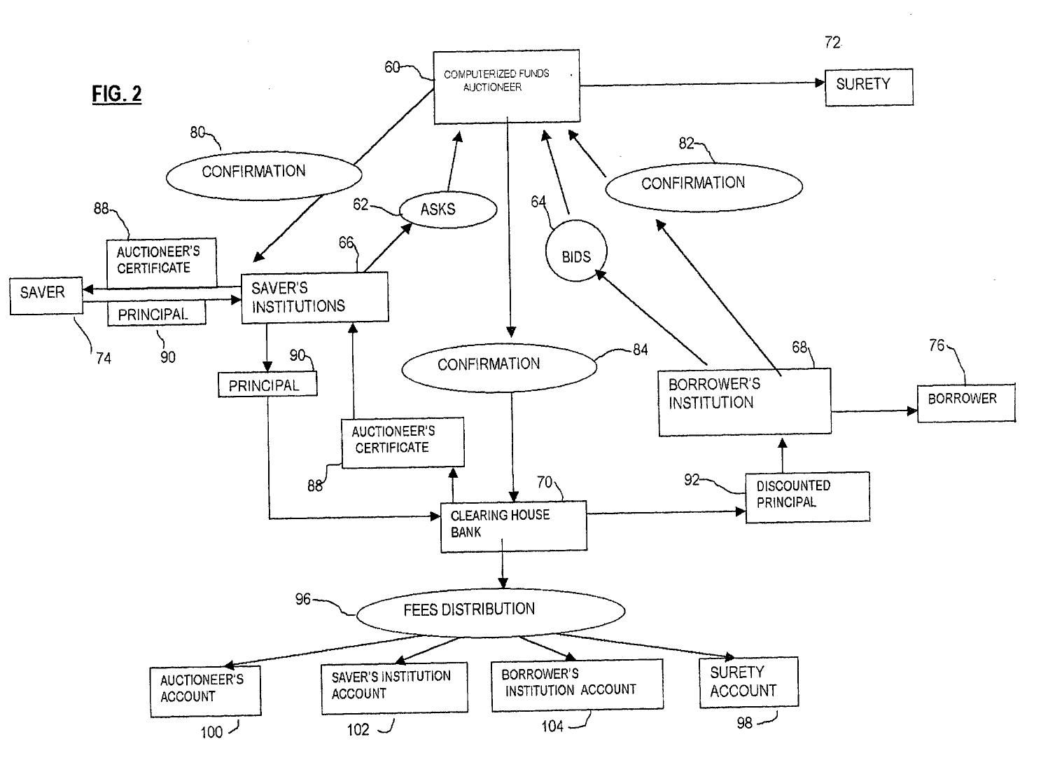

FIG. 2 is a block diagram depicting the method of the novel invention;

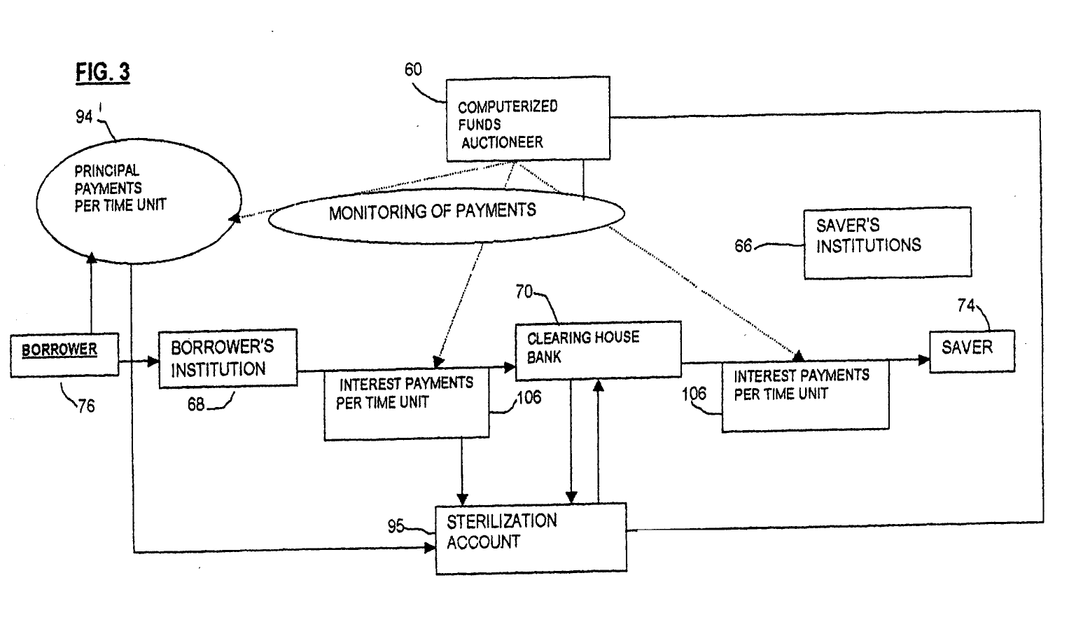

FIG. 3 is a block diagram showing funds flow for the method of the invention; and;

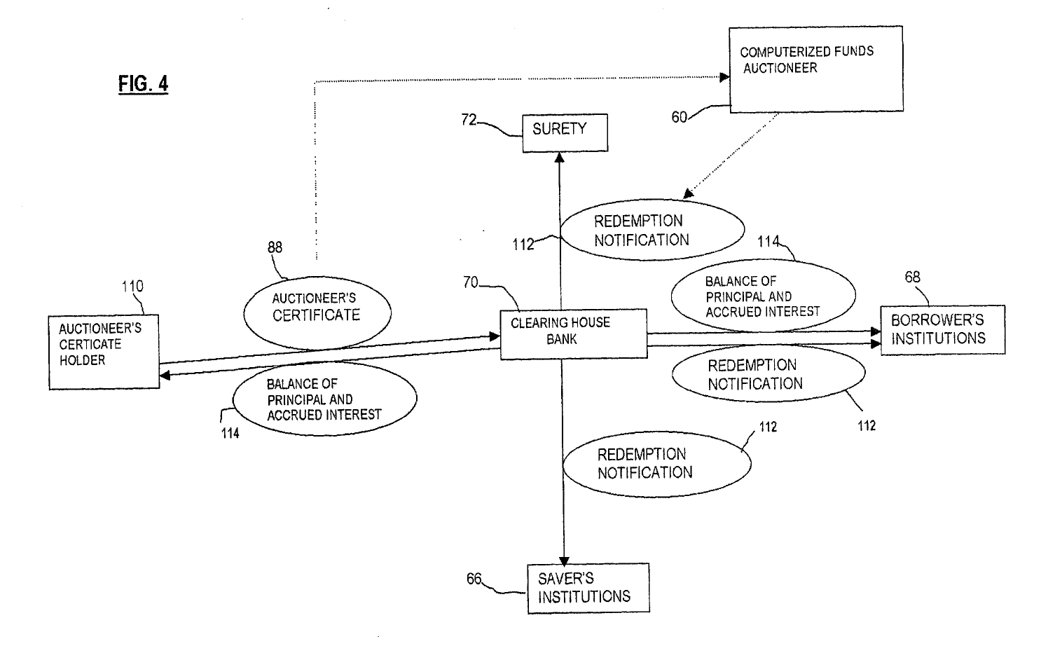

FIG. 4 is a block diagram showing the redemption aspects of the method.

### SPECIFICATION OF THE PREFERRED EMBODIMENT

The novel method and system are each specifically engineered and designed for saver's and borrower's institutions based on each meeting certain pre-defined liquidity criteria.

Only a portion of the over $250 billion market is eligible for placement through the novel computer based savings and loan auctioneering because the system has been determined to work most efficiently when network member institutions meet stricter capital requirements than public regulatory agencies require. Empirical studies have shown that the level of capital at an institution has a direct impact on its ability to meet unexpected cash outflows. Capital is also an indicator of the ability of an institution's creditors (i.e. depositors, certificate holders, note holders) to recover their investments after a default.

The novel computer based savings and loan auctioneering system uses, as a basis for its membership criteria, the benchmark capital to assets ratios employed by the Federal Deposit Insurance Corporation (FDIC), the Federal Home Loan Bank Board (FHLB), and the National Credit Union Association (NCUA). This novel system adds a double digit percentage increase as a safety factor, e.g. at least 50% more, to each of these ratios as an unprecedented level of security. The chart on the following page lists the amount of assets within each institutional group which qualifies members of each group to be a part of and participate in the novel system:

| | AGENCY | AUCTIONEER'S | QUALIFIED |
|---|---|---|---|
| | CAPITAL | CAPITAL | ASSETS |
| INSTITUTION | REQUIRED | REQUIRED | ($BILLIONS) |
| Commercial Banks | 6.0% (5) | 9.0% | $20 |
| Credit Unions | 6.3 (6) | 9.1 | 32 |
| Savings and Loans | 3.0 (7) | 4 5 | 8 |
| Mutual-Savings Banks | 3.0 (8) | 4 5 | 3 |
| Total Market | | | $63 |

AGENCIES
(5) FDIC equity to assets ratio
(6) NCUA net worth over total assets ratio (industry average for 1980)
(7) FHLB net worth over total assets ratio
(8) FDIC net worth over total assets ratio

For qualifying institutions, the novel computer based savings and loan auctioneering system provides an automated transaction service that will match savers and borrowers throughout the United States and the world. Transactions are evidenced by promissory notes with fixed interest rates, maturities, and principal amounts in denominations ranging from $5,000 to $100,000.

The present invention provides a system and method for conducting electronic loan and certificate of deposit auctions solely between financial institutions in a novelly structured method. The sole participants are the borrower's institutions and saver's institutions. Successful implementation also requires a funds auctioneer as a processing agent, a surety organization, or guarantor bank, a unique sterilization account, and a clearinghouse.

In accordance with the present invention, a prospective borrower's institution or group of borrower's institutions with an array of pre-processed and pre-approved loans for specified terms and denominations and a prospective saver's institution or group of saver's institutions with an array of preprocessed and pre-approved deposits for specified terms and denominations, by way of the entry criteria for using the system and method obtain a loan transaction or a certificate of deposit at more favorable terms than those institutions would have obtained by traditional ways. The system and method of the present invention offers click-of-the-mouse convenience for both borrower's and saver's institutions. Not only can a borrower's financial institution apply for a loan auction from a computer connected to a computer network or the internet at any location and at any time of the day and a prospective saver's institution submit a bid for a loan from a computer over a computer network or the internet, issuance of the CD, term payments of interest and principal, and redemption are automated.

FIG. 1 is a block diagram of a computer system 10 of the present invention. Computer system 10 comprises at least one computer 20, an auction network server, for example, preferably connected to a plurality of computer workstations 22, 24, 26, and 28. Computer 20 is connected to an auctioneer's LAN and website 30. The computer 20 runs the auctioneer's bid and ask management software 32. The website or auctioneer's LAN 30 is connected via the bid and ask management software 32 to a plurality of borrower's institutions via borrower's institution access terminals 34 and 36, for example. The website or auctioneer's LAN 30 is also connected via the bid and ask management software 32 to a plurality of saver's institutions via saver's institution access terminals 44 and 46, for example.

Referring further to FIG. 1, there is shown access by a surety company to the auctioneer at the auctioneer's LAN 30 via a surety access terminal 48. The surety accesss terminal 48 is interconnected to a clearinghouse bank via a clearinghouse bank terminal 50, which accesses the electronically stored transaction data of the auctioneer either directly as records and yield curves and related accessible data 52 or via connection to the auctioneer's LAN 30.

Computer 20 is a computer generally known in the field of computers and computer networks as a server computer or computer server. A server computer contains hardware and software adapted to communicate with other computers over a computer network and to make available computer files or software stored in the server computer or a storage device containing records and yield curves and related accessible data 52, for example, connected thereto such that they can be accessed by an approved and pre-qualified institution from another computer connected to the network. connected to the network.

Although one computer server is adequate for the purpose of this invention to achieve the benefit of redundancy, data security and distributed computing, more than one computer server is preferred. In a preferred embodiment, the computer system of the present invention includes a plurality of computer servers connected to LAN 30, in addition to computer server 20 shown in FIG. 1. For example, one server computer may be dedicated to perform functions of communications with the borrower's institution access terminal 34; another server computer for communications with the saver's institution access terminal 44; and yet another computer server for communications with the surety access terminal 48. In a preferred embodiment, more than one computer network is used. For convenience, however, only one computer server 20 is shown in the drawings.

Referring again to FIG. 1, in the preferred embodiment, computer 20 is connected to a local area network (“LAN”) 30. LAN 30 is connected via bid and ask management software 32 to a plurality of computers or access terminals 34, 36, 44, and 46. From any one of access terminals 34, 36, 44, and 46, an institution can access, through LAN 30, computer 20 to work on the software 32 or database contained therein as accessible data 52. Live on-line communications can also be carried out between a member institution, for example saver's institution terminal 46 at any one of computers 20, 22, 24, 26 and 28 on LAN 30 and a borrower's institution via borrower's institution access terminal 36.

The computer system of the present invention operates as follows: Computer 20 and/or the auctioneer's website or LAN 30 makes available current bids and asks and related data for review that my be viewed, acted on and/or downloaded by a prospective institutution, for example via the access terminals 34, 36, 44, or 46. Software 32 guides the transacting institution step-by-step and sends back a confirmation to a source terminal (as explicitly depicted in FIG. 2). After receiving the electronic confirmation, computer 20 forwards confirmation to the other institution via its access terminal and, as depicted in FIG. 2, confirms the transaction to the surety access terminal 48 and the clearinghouse or bank via bank terminal 50.

Referring to FIG. 2, a preferred embodiment of the novel method of the invention is illustrated in block diagram form. There is shown a computer funds auctioneer 60 electronically receiving a set of asks 62 and set of bids 64. The asks 62 and bids 64 are electronic messages indicating the principal, term, and interest rate as well as an electronic signature of the submitting institution and optionally whether the submission is good for the day, good until cancelled, or good for some specific period of time.

The method shown in FIG. 2 is implemented through the computer terminals illustrated in FIG. 1 and provided by the novel computer based savings and loan auctioneering system. Each of a plurality of saver's institutions 66 and borrower's institutions 68 is interlinked to the auctioneer 60, a clearinghouse bank 70, and a surety 72 via a transaction based communications network or via the internet. Through the novel computer based savings and loan auctioneering system, a depository or one of the saver's institutions 66 submits a required rate of return (ask price), maturity and dollar amount on behalf of the saver 74, one of the borrower's institutions 68 submits a required borrowing rate (bid), maturity and dollar amount on behalf of the borrower 76.

For specific maturities, which range from 1 to 5 years in six month increments, a server or central processing unit electronically and often substantially instantaneously matches bids 64 with asks 62, priced in requisite fixed dollar amounts. Cash settlement (on behalf of the borrower 76 and saver 74) is accomplished through a clearinghouse bank 70 or a clearinghouse that is an essential and a necessary part of the novel computer based savings and loan auctioneering system whereby funds transactions are made and confirmed by the computerized funds auctioneer 60 via electronic confirmations 80, 82, and 84.

Shown in FIG. 2, the funds auctioneer 60 issues a certificate of deposit or electronic auctioneer's certificate 88 authenticated using an electronic signature through the bank 70. The certificate 88 is a prime rated negotiable promissory note which is collateralized by the borrower 76. Principal 90 (and interest, see FIG. 3) due to the saver 74 is primarily guaranteed by the specific institution to the transaction from the borrowers institutions 68. Payment is secondarily guaranteed by the surety 72 that is required in this novel method to be prime rated. The third party which guarantees the auctioneer's principal 90, discounted principal 92, and principal and interest payments per unit time 94 (see FIG. 3) is the specific saver's institution representing the saver from the saver's institutions 66. It is essential to the novel method and the advantages thereof that the auctioneer's certificate 88 of deposit is a contingent liability to the guarantors, and is reserved against only by the borrower's institutions 68.

Again referring to FIG. 2, payment to the novel computer based savings and loan auctioneering system consists of a part of a fees distribution 96 that is a cash fee equal to a fractional percentage, e.g. one-half of one percent, of the face value of each auctioneer's certificate, for example. The auctioneer's fee is electronically paid by the clearinghouse bank 70 or a clearinghouse from the fee distribution 96 into an auctioneer's account 100. A similar cash fee from the fees distribution 96, one percent, for example, is also paid to the surety 72 via a surety account 98. Both the borrower's institutions 68 and the saver's institutions 66 may each price a cash fee for each transaction. These fees are electronically paid into a saver's institution account 102 and a borrower's institution account 104. All fees from fee distribution 96 are paid at the time of settlement by the clearinghouse bank 70 or a clearinghouse and are reflected as discounted principal 92 due to the borrower 76.

With every auctioneer's certificate 88 placed, the borrower's institutions 68 will also have free use of accrued monthly amortization payments, namely, the principal payments per time unit 94 made by the borrower 76 into a sterilization account 95 (non-interest bearing deposit account) maintained by the funds auctioneer 60.

As shown in FIG. 3, throughout the term of the auctioneer's certificate 88 of deposit, the borrower's institutions 68 receives monthly principal payments per time unit 94 and interest payments per time unit 106 from the borrower 76 which accrue in the sterilization account 95. From this account, interest payments per time unit 106 are passed through to the saver 74 on a quarterly or other time unit basis. The balance of the sterilization account 95 represents interest free investable funds for the borrower's institutions 68 over the term of the auctioneer's certificate 88.

Shown in FIG. 4, at maturity the auctioneer's certificate holder 110 via one of the applicable saver's institutions 66 issues a redemption notification 1 12 to the auctioneer 60 and presents the certificate 88 for redemption at the clearinghouse bank 70. Upon notification of redemption by the clearinghouse bank 70 the matching one of the borrower's institutions 68 initiates an electronic funds transfer of a principal balance and accrued interest 114 for final settlement and payment of the balance of principal and accrued interest 114 due on the auctioneer's certificate 88.

In addition to the direct economic benefits listed above, the novel computer based savings and loan auctioneering system when implemented over a communications network such as the internet also provides many of the operating and accessibility functions associated with internet securities trading practices. By providing support functions, such as, an automated clearinghouse and extensive record keeping, the novel computer based savings and loan auctioneering of bids and asks actually reduces the likelihood of losses charged to the bank due to operating errors.

The novel system and method also reduces the overhead associated with marketing deposit products, since saver funds can be accessed at the click of a mouse. All of this relieves member financial institutions and banks of unnecessary operational burdens, allowing them to offer more competitive rates to their customers or increase their own profitability.

Institutions qualified to participate in the novel computer based savings and loan auctioneering system perform outwardly in the same capacity as they do now. An institution is still responsible for evaluating the credit worthiness and collateral of its borrowing customers utilizing the related prior art software or similar software borrowing customers utilizing the related prior art software or similar software referenced herein and their associated systems before it accesses the novel computer based savings and loan auctioneering system. Upon compliance with the funds auctioneer's credit risk standards, the borrower's institutions query the novel computer based savings and loan auctioneering system over an available communications network system or the internet for a yield curve comprised of consummated transactions at six month intervals, for example, ranging from one to five years.

The yield curve serves as a basis for determining the approximate cost of funds for the borrower. The saver's institutions also have an opportunity to query the novel computer based savings and loan auctioneering system for the same information. In this case, the curve represents average rates of return the institution can offer its customers.

In accordance with the operational design of the system, once an institution has determined its competitive strategy on investment of saver's funds, it inputs the following information through the novel auctioneering system as shown in FIG. 1: (1) account information (e.g. saver name, address, name of originating institution, etc.); (2) A required rate of return (ask price), maturity, principal amount, and its own cash fee for placing funds Note: Account information is not revealed to either the borrower's or the saver's institution unless an auction, match, or transaction is electronically implemented by the funds auctioneer 88.

An institution seeking such funds uses the novel system to view a list of all ask prices (in percent) and associated cash fees (in basis points) submitted by institutions

| 1 YEAR | | | 1.5 YEARS | | | 2 YEARS | | |
|---|---|---|---|---|---|---|---|---|
| Prin. | Rate | Fee | Prin. | Rate | Fee | Prin | Rate | Fee |
| 5000 | 8.80 | 64 | 5000 | 9.10 | 60 | 10000 | 9.2 | 59 |
| 10000 | 9.22 | 53 | 10000 | 9.25 | 45 | 15000 | 9.29 | 62 |
| 10000 | 9.09 | 58 | 15000 | 9.10 | 30 | 15000 | 9.47 | 48 |
| 25000 | 8.90 | 69 | 15000 | 9.40 | 50 | 30000 | 9.90 | 67 |
| 50000 | 9.87 | 60 | 90000 | 10.00 | 31 | 95000 | 10.16 | 45 |

From a terminal display, borrower's institutions 68 choose an offering which provides an adequate return on capital and a competitive borrowing rate for its customer. The institution then inputs its account information and an acceptance message. The system confirms the transaction through both the novel computer based savings and loan auctioneering system 10 implemented over a communications network terminal and/or with a hard copy printed at each institution.

For those offerings which are not matched, the saver's institutions 66 have the option of either leaving their offers on the system for a pre-specified time or with acceptable limiting parameters or inputting more competitive quotes.

After a bid from the bids 64 and ask price from the asks 62 are matched and confirmation 84 is received, settlement is then made between saver 74 and borrower 76. The institution representing the saver 74 receives the principal 90 and initiates a funds transfer (through the novel computer based savings and loan auctioneering system implemented over a communications network terminal), using the clearinghouse bank 70 as agent. The clearinghouse bank 70 or clearinghouse is responsible for reconciling the record of transaction it receives from auctioneer 60 with the funds transfer advice it receives from the specified transaction associated with one of the saver's institutions 66. The clearinghouse bank 70 then receives the full face value of the auctioneer's certificate 88 of deposit and deducts the following. (a) The origination fee paid to the institution representing the saver 74; (b) The placement fee paid to the institution representing the borrower 76; (c) The fee paid to the auctioneer 60; and, (d) The fee paid to the surety 72 guaranteeing the auctioneer's certicate 88.

When the above fees are deducted and credited to the appropriate accounts 98, 100, 102, and 104, the clearinghouse bank 70 distributes (via electronic funds transfer) the residual amount discounted principal 92 to the institution representing the borrower 76 which then passes the funds to the borrower 76. Upon settlement, the auctioneer's certificate 88 is electronically issued by the clearinghouse bank 70 to the institution representing the saver 74.

Users of the novel invention are vastly more efficient because risk is transferred to savers and borrowers since the users sell their loans. The loans are actually sold by the funds auctioneer at the time they are made. By taking on less risk, these institutions generate higher returns on less capital. User institutions need less capital than with a traditional consumer loan to generate the same level of income. This is because an institution's capital is allocated only as sterilization account payments become investable cash assets over the life of the auctioneer's certificate 88. A loan requires that capital be allocated to the face value as soon as the instrument is originated.

The following loan comparison chart uses data from the following table:

Auctioneer's Loan versus Conventional Loan Comparison
ASSUMPTIONS
Auctioneer's Loan versus Conventional Loan Comparison
ASSUMPTIONS

| | | |
|---|---|---|
| DISCOUNT RATE | = | 6.4% |
| INVESTMENT RATE | = | 9.6% |
| AUCTIONEER'S MATCH RATE | = | 10.0% |
| CONVENTIONAL LOAN RATE | = | 15 0% |
| SAVER'S INSTITUTION FEE | = | 25 basis points |
| BORROWER'S INSTITUTION FEE | = | 75 basis points |
| AUCTIONEER'S FEE | = | 50 basis points |
| SURETY FEE | = | 100 basis points |

Compared below are returns on capital generated from a typical one year consumer loan at 15% and a one year loan via the computerized funds auctioneering system 10 at 10% each with a $10,000 face value:

| | Auctioneer's | Regular |
|---|---|---|
| | Loan | Loan |
| Interest income | $481 | $1345 |
| Non-interest Income (fees) | 75 | 0 |
| Interest Expense | 0 | (635) |
| Non-interest Expense | (146) | (293) |
| Net Income | 410 | 417 |
| Capital Allocated | 739 | 800 |
| Return on Capital | 56% | 52% |

In addition to making more efficient use of capital, the novel computer based savings and loan auctioneering system implemented over a communications network's globalized computer base will permit its member institutions to take full advantage of all fluctuations in their local economies. During periods of sick loan demand, an institution can collect cash fees with minimal risk by placing excess saver funds in areas of the country where there is increased demand for credit, and since the saver's institution does does not have to reserve against its guarantee (this has already been done by the borrower's institution), its fees for accessing the novel auctioneer's certificate of deposit compare very favorably with stand-by letters of credit and other off-balance sheet financial products.

In summary, shown below is an actual example of improved rate of return to the borrower's institutions using the novel system and method of the invention:

AUCTIONEER'S RETURN IN DOLLARS
TO BORROWER'S INSTITUTION

| Period | | | |
|---|---|---|---|
| Income | Monthly Cash flow | Investable Funds | Investment |
| 1 | 879 | 879 | 7 |
| 2 | 879 | 1758 | 14 |
| 3 | 629 | 2387 | 19 |
| 4 | 879 | 3267 | 26 |
| 5 | 879 | 4146 | 33 |
| 6 | 629 | 4775 | 38 |
| 7 | 879 | 5654 | 45 |
| 8 | 879 | 6533 | 52 |
| 9 | 629 | 7162 | 57 |
| 10 | 879 | 8042 | 64 |
| 11 | 879 | 8921 | 71 |
| 12 | 629 | 9558 | 76 |
| | | | 481 |

NPV or New Present Value = $9234
Allocated Capital = 739 = 8% of NPV = 8% × $9234

For comparison, shown below is an actual example of the lesser rate of return to the borrower's institutions with a comparable conventional loan:

PRIOR ART OR CONVENTIONAL LOAN
RETURN TO BORROWER'S
INSTITUTION

| | Monthly | Interest Portion | Investable | Investment | Total |
|---|---|---|---|---|---|
| Period | Cashflows | of Payment | Funds | Income | Income |
| 1 | 903 | 125 | 900 | 7 | 132 |
| 2 | 903 | 115 | 1806 | 14 | 129 |
| 3 | 903 | 105 | 2708 | 22 | 127 |
| 4 | 903 | 95 | 3610 | 29 | 124 |
| 5 | 903 | 85 | 4513 | 36 | 121 |
| 6 | 903 | 75 | 5415 | 45 | 120 |
| 7 | 903 | 64 | 6318 | 50 | 114 |
| 8 | 903 | 54 | 7221 | 58 | 112 |
| 9 | 903 | 43 | 8123 | 65 | 108 |
| 10 | 903 | 33 | 9026 | 72 | 105 |
| 11 | 903 | 22 | 9928 | 79 | 101 |
| 12 | 903 | 11 | 10831 | 86 | 97 |

Allocated Capital = 8% of $10,000 = $800 NPV = $1345

Shown below in chart form is the borrower's cost of finds:

BORROWER'S COST OF FUNDS

| | Auctioneer's | Conventional |
|---|---|---|
| Period | Cashflows | Loan Cashflows |
| 0 | 9750 | 10000 |
| 1 | −879 | −903 |
| 2 | −879 | −903 |
| 3 | −879 | −903 |
| 4 | −879 | −903 |
| 5 | −879 | −903 |
| 6 | −879 | −903 |
| 7 | −879 | −903 |
| 8 | −879 | −903 |
| 9 | −879 | −903 |
| 10 | −879 | −903 |
| 11 | −879 | −903 |
| 12 | −879 | −903 |

And, comparing the APR's indicates the following added utility using the system and method of the novel invention.

Annual Percentage Rate via Auctioneer's System =
14.81%
Annual Percentage Rate via Conventional Loan System =
15.00%

Examining the novel system from the saver's side of the transaction the following additional advantage is shown:

SAVER'S YIELD VIA AUCTION SYSTEM

| PERIOD | CASHFLOWS |
|---|---|
| 0 | −10000 |
| 1 | 250 |
| 2 | 256 |
| 3 | 263 |
| 4 | 10269 |

YIELD = 10.37%

One of ordinary skill in this art will readily appreciate that the present invention is not limited to the exact construction and methodology which has been described above and which is illustrated in the accompanying drawings, and that various modifications and changes can be made without departing from natural equivalents within the scope of what is evident from the disclosure. It is intended that the scope of the invention only he limited by the appended claims pursuant to the doctrine of equivalents.

What is claimed is:

1. A computer system for conducting a savings and loan auction between a plurality of saver's institutions acting on behalf of a plurality of savers and a plurality of borrower's institutions acting on behalf of pre-qualified borrowers for a plurality of pre-set amounts of offered principal, each offered principal being offered for one of a plurality of pre-set time periods via a funds auctioneer, said computer system comprising:
(a) at least one computer maintained by said funds auctioneer;
(b) at least one computer network connected to said computer;
(c) means for receiving an electronic savings deposit offer and ask rate from a prospective saver's institution over said at least one computer network;
(d) means for receiving an electronic loan request and bid rate from a prospective borrower's institution over said at least one computer network;
(e) means, located at said funds auctioneer, for electronically sorting, matching, and selecting electronic savings deposit offers and ask rates which match with electronic loan requests and bid rates to form a plurality of matches of bids and asks or transactions,
(f) means, operated by said funds auctioneer, for electronically confirming each said match of a bid and ask to each said saver's institution and each said borrower's institution which is a party to the matched bid and ask or transaction over said at least one computer network or another computer network;
(g) means, operated by said funds auctioneer, for electronically confirming each said match of a bid and ask to a clearinghouse and a surety, specifying each said saver's institution and each said borrower's institution, which is a party to the matched bid and ask or transaction, over said at least one computer network or another computer network;
(h) means, operated by said funds auctioneer, for electronically monitoring payments of principal and interest from each borrower's institution that is a party to a transaction via the clearinghouse bank to each saver's institution that is a party to the matched transaction;
(i) means for electronically issuing a negotiable certificate of deposit from the auctioneer to a saver via saver's institution and the clearinghouse bank;
(j) means for electronically redeeming and issuing notification of redemption of said auctioneer's negotiable certificate of deposit to the surety, the clearinghouse bank, the saver's instition, and the borrower's institution;
(k) means, operated by said funds auctioneer, for electronically monitoring payments of principal and interest from each borrower's institution that is a party to a transaction via the clearinghouse to each saver's institution that is a party to the matched transaction; and,
(l) means for electronically transferring final principal and accrued interest from the borrower's institution via the clearinghouse bank to the auctioneer's certicate holder and canceling the auctioneer's certificate of deposit.

2. The computer system of claim 1 further comprising a means for electronically transferring a discounted principal to the borrower's institution for transfer to the borrower.

3. The computer system of claim 2, further comprising means for electronically distributing a fee, the difference between the principal and discounted principal, to the auctioneer, the borrower's institution, the saver's institution, and the surety.

4. The computer system of claim 1 further comprising a local area network (“LAN”) connected to said computer, said local area network including a plurality of computers.

5. A method for conducting a savings and loan auction between a plurality of saver's institutions acting on behalf of a plurality of savers and a plurality of borrower's institutions acting on behalf of pre-qualified borrowers for a plurality of pre-set amounts of offered principal, each offered principal being offered for one of a plurality of pre-set time periods via a finds auctioneer over a computer system comprising at least one computer and at least one computer network connected thereto, said method comprising the steps of:
(a) providing at least one computer maintained by said funds auctioneer;
(b) providing at least one computer network connected to said computer;
(c) receiving an electronic savings deposit offer and ask rate from a prospective saver's institution over said at least one computer network;
(d) receiving an electronic loan request and bid rate from a prospective borrower's institution over said at least one computer network;
(e) said funds auctioneer, electronically sorting, matching, and selecting electronic savings deposit offers and ask rates which match with electronic loan requests and bid rates to form a plurality of matches of bids and asks or transactions,
(f) said funds auctioneer, electronically confirming each said match of a bid and ask to each said saver's institution and each said borrower's institution which is a party to the matched bid and ask or transaction over said at least one computer network or another computer network;
(g) said funds auctioneer, electronically confirming each said match of a bid and ask to a clearinghouse and a surety, specifying each said saver's institution and each said borrower's institution, which is a party to the matched bid and ask or transaction, over said at least one computer network or another computer network;
(h) said funds auctioneer, electronically monitoring payments of principal and interest from each borrower's institution that is a party to a transaction via the clearinghouse bank to each saver's institution that is a party to the matched transaction;
(i) electronically issuing a negotiable certificate of deposit from the auctioneer to a saver via saver's institution and the clearinghouse bank;
(j) electronically redeeming and issuing notification of redemption of said auctioneer's negotiable certificate of deposit to the surety, the clearinghouse bank, the saver's instition, and the borrower's institution; and
(k) electronically monitoring payments of principal and interest from each borrower's institution that is a party to a transaction via the clearinghouse bank to each saver's institution that is a party to the matched transaction; and,
(l) electronically transferring final principal and accrued interest from the borrower's institution via the clearinghouse to the auctioneer's certicate holder and canceling the auctioneer's certificate of deposit.
